(19) United States
(12) Patent Application Publication
(10) Pub. No.: US 2013/0182874 A1
(43) Pub. Date: Jul. 18, 2013

(54) RECHARGEABLE PARTIALLY IMPLANTABLE HEARING INSTRUMENT

(71) Applicant: Felix Buehlmann, Lausanne (CH)

(72) Inventor: Felix Buehlmann, Lausanne (CH)

(73) Assignee: ADVANCED BIONICS AG, Zug (CH)

(21) Appl. No.: 13/813,861

(22) PCT Filed: Aug. 3, 2010
(86) PCT No.: PCT/EP10/61309

§ 371 Date: Apr. 4, 2013

(51) Int. Cl. H04R 25/00

(52) U.S. Cl. CPC H04R 25/602
USPC 381/312

(57) ABSTRACT

A system has an implantable unit and an external unit. The external unit is fixable at the patient's head and has an audio signal source, an audio signal processing unit for processing audio signals from the audio signal source, a rechargeable power source, a transmitter for transmitting processed audio signals via a transcutaneous audio link to the implantable unit and a power transmission coil for transmitting power via a transcutaneous power link to the implantable unit. The implantable unit has a stimulator for a patient's middle ear or inner ear component according to the processed audio signals. The external unit is coupleable to the inductive charging device for inducing an AC voltage in the power transmission coil. The external unit has a recharging circuitry for transforming the AC voltage induced in the power transmission coil by the charging device into a charging current for recharging the rechargeable power source.

### BACKGROUND OF THE INVENTION

1. Field of the Invention

The present invention relates to a system comprising a partially implantable hearing instrument and a charging device for recharging the power source of an external unit of the hearing instrument, which external unit is to be fixed at the patient's head and supplies an implantable unit of the hearing instrument with power via a transcutaneous power link.

2. Description of Related Art

Typically, both electro-acoustic hearing aids and the external part of partially implantable hearing instruments, such as cochlea implants (CIs) and middle ear hearing devices (IMEHDs) are powered by zinc-air non-rechargeable batteries. Such batteries must be replaced frequently, with such replacement being cumbersome to the patient in view of the small size of such batteries. In addition, the battery door is a potential source of moisture ingress into the hearing instrument housing, resulting in corrosion and malfunction. In particular, in devices with high current consumptions, such as CIs and IMEHDs, battery lifetime is typically limited to one week or less, resulting in high operating costs.

As an alternative, rechargeable batteries may be used which are recharged through a direct electrical connection to a charging device. This requires electrical contacts which are open to the environment and hence could become corroded. In addition, such contacts require accurate positioning of the hearing instrument with regard to the charging device.

U.S. Patent Application Publication 2008/0205678 A1 relates to a BTE (behind-the-ear) hearing aid containing a rechargeable battery which may be recharged by using a telephone coil, a data transmission coil or coils provided at the loudspeaker or the microphones of the hearing aid, with the hearing aid beiung placed into the charging bay of an inductive charging device for being recharged.

U.S. Pat. No. 4,379,988 relates to a hearing aid comprising a rechargeable battery, an iron core inductor molded into the body of the hearing aid and a light-emitting diode (LED) which is connected in series with the inductor across the rechargeable battery. A battery charger is provided having a small plastic cup and a tapped inductor wound around the outside of the cup and connected into an oscillator circuit. For recharging of the hearing aid battery, the hearing aid is removed from the ear and is placed into the plastic cup of the battery charger, with the LED being visible to the user in order to indicate by its brightness when the hearing aid is located in its optimum position in the cup of the charger.

German Patent DE 36 33 722 C1 relates to a hearing aid comprising a rechargeable battery which differs from the hearing aid described in U.S. Pat. No. 4,379,988 in that the coil located in the hearing aid forms part of a resonant circuit which is tuned to the frequency of the high-frequency generator of the battery charger.

International Patent Application Publication WO 2006/089047 A2 relates to a fully implantable cochlea implant which is recharged by using an external charger device, wherein the external charger device and the implant housing includes magnets to facilitate retentive juxtaposed positioning of the external charger device relative to the implant.

### SUMMARY OF THE INVENTION

It is an object of the invention to provide for a partially implantable hearing instrument which can be recharged in a convenient manner, while keeping complexity of the manufacturing process and space requirements of the hearing instrument relatively low.

According to the invention, this object is achieved by a system as described herein.

The invention is beneficial in that, by using the power transmission coil of the external unit of the hearing instrument for inducing a charging current to be used for recharging the rechargeable power source of the external unit by coupling it to an inductive charging device, convenient recharging of the power source of the external unit of the hearing instrument is enabled, namely in a wireless manner which eliminates the need for electrical contacts and which eliminates the need for removal of the batteries for recharging, while nevertheless the need for a separate charging coil of the external unit of the hearing instrument is avoided.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a cross-sectional view of an example of an implantable hearing instrument according to the invention after implantation;

FIG. 2 is a block diagram of the system of FIG. 1;

FIGS. 3 and 4 show two examples of a magnetic fixation system of the external unit of a hearing aid according to the invention;

FIG. 5 is a side view of the external unit of the hearing instrument of FIGS. 1 and 2 when being coupled to a recharging device;

FIG. 6 is a block diagram of the charging device of FIG. 5; and

FIG. 7 shows an example of the recharging circuitry of the external unit of a hearing aid according to the invention.

### DETAILED DESCRIPTION OF THE INVENTION

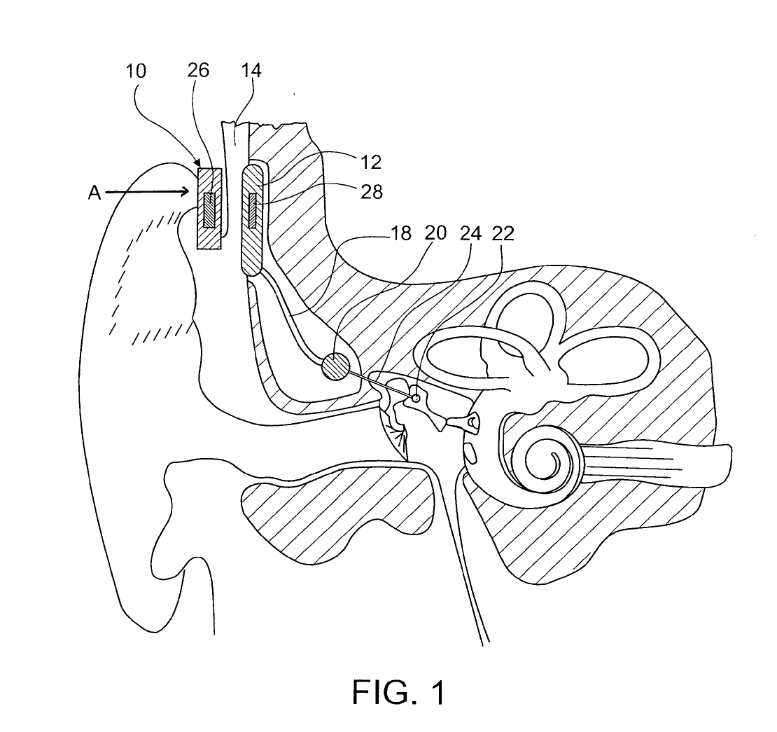

FIG. 1 shows a cross-sectional view of the mastoid region, the middle ear and the inner ear of a patient after implantation of an example of a hearing aid according to the invention, wherein the hearing aid is shown only schematically. The system comprises an external unit 10, which is worn outside the patient's body at the patient's head, and an implantable unit 12, which is implanted under the patient's skin 14, usually in an artificial cavity created in the user's mastoid. The implantable unit 12 is connected via a cable assembly 18 to an actuator 20. While in FIG. 1 an electromechanical actuator coupled to an ossicle 22 via a coupling rod 24 is shown, the actuator 20 also may be an electromechanical actuator coupled directly to the cochlear wall, an actuator directly acting on the perilymph or a cochlear electrode.

The external unit 10 is fixed at the patient's skin 14 in a position opposite to the implantable unit 12, for example, by magnetic forces created between a magnetic fixation arrangement 26 provided in the external unit 10 and a cooperating magnetic fixation arrangement 28 provided in the implantable unit 12, respectively.

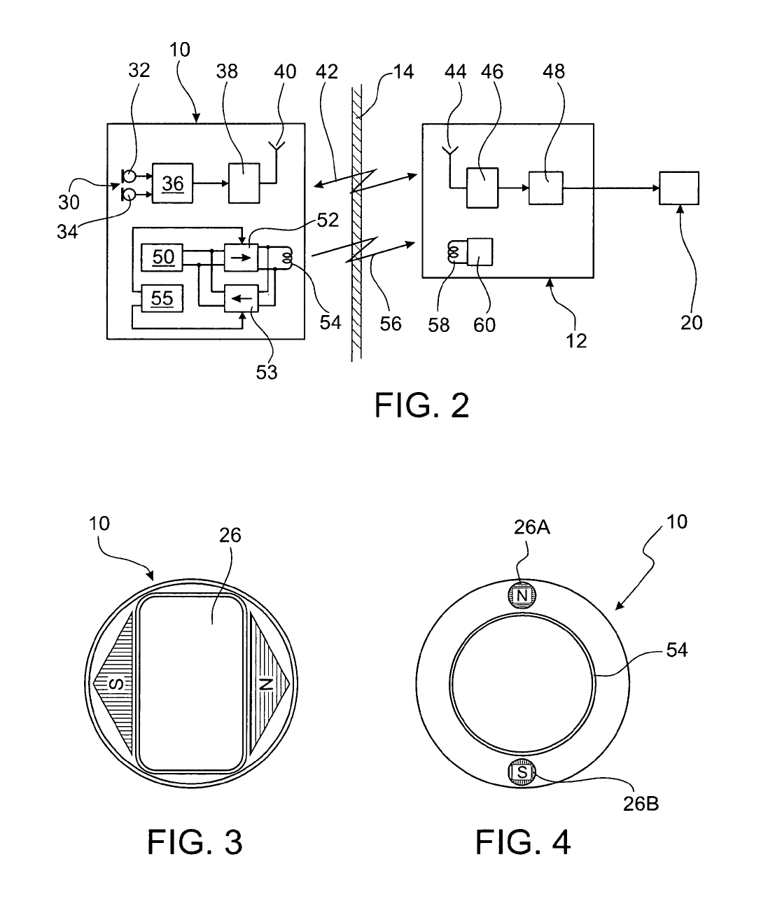

An example of a block diagram of the system of FIG. 1 is shown in FIG. 2. The external unit 10, which is typically arranged at a location behind the user's ear, includes a microphone arrangement 30, which typically comprises at least two spaced-apart microphones 32 and 34, for capturing audio signals from ambient sound, which audio signals are supplied to an audio signal processing unit 36 wherein they undergo, for example, acoustic beamforming. The audio signals processed by the audio signal processing unit 36 are supplied to a transmission unit 38 connected to a transmission antenna 40 in order to enable transcutaneous transmission of the processed audio signals via a wireless (e.g., inductive) data link 42 to the implantable unit 12 which comprises a receiver antenna 44 connected to a receiver unit 46 for receiving the transmitted audio signals. The received audio signals are supplied to a driver unit 48 which drives the actuator 20.

The external unit 10 also comprises a rechargeable power supply 50, such as a rechargeable electrochemical battery, a power transmission unit 52 and a power transmission antenna 54 for transmitting power to the implantable unit 12 via a wireless power link 56. The implantable unit 12 comprises a power receiving antenna 58 and a power receiving unit 60 for powering the implanted electronic components with power received via the power link 56.

Preferably, the audio signal antennas 40, 44 are separated from the power antennas 54, 58 in order to optimize both the audio signal link 42 and the power link 56. However, if a particularly simple design is desired, the antennas 40 and 54 and the antennas 44 and 58 could be physically formed by a single antenna, respectively.

The external unit 10 also comprises a recharging circuitry 53 and a control unit 55 which controls the power transmission unit 52 and the recharging circuitry 53.

The rechargeable battery 50 supplies a DC current/voltage to the power transmission unit 52 which generates a corresponding AC output signal to the power transmission coil 54 in order to generate an alternating magnetic field necessary for establishing the inductive power link 56. During normal operation of the external unit 10, i.e. when the external unit 10 is worn at the patient's head in order to power the implantable unit 12 and to transmit audio signals to the implantable unit 12, the recharging circuitry 53 is turned off by the control unit 55.

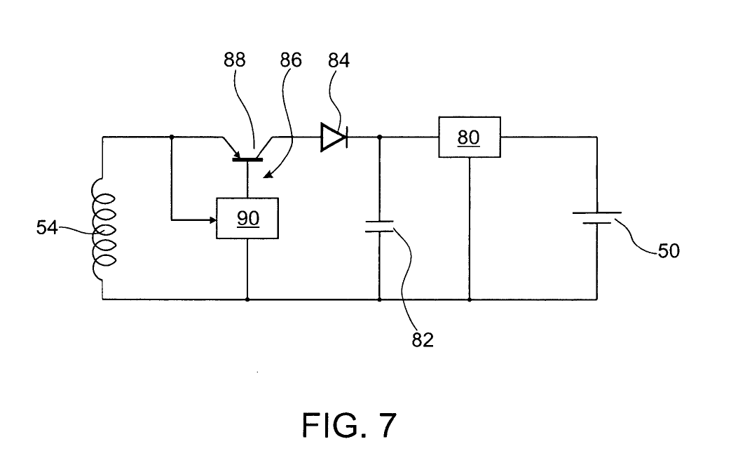

An example of the recharging circuitry 53 is shown in FIG. 7, wherein the recharging circuitry 53 comprises a charging control unit 80 for controlling the charging current applied to the rechargeable battery 50, a capacitor 82, a diode 84, and charging mode switching unit 86 comprising a transistor 88 controlled by a command element 90. The command element 90 may comprise, for example, a voltage sensor sensing the voltage across the power transmission coil 54, so that the recharging circuitry 53 can be automatically switched on once the (induced) voltage sensed by the element 90 at the transmission coil 54 exceeds a certain threshold, thereby indicating that the external unit 10 has been coupled to a charging device. In this example, the charging mode switching unit 86 takes over the role of the control unit 55 of FIG. 2.

In FIGS. 3 and 4 two examples of a magnetic fixation system 26 of the external unit 10 are shown; it is to be understood that, while in FIGS. 3 and 4 only the magnets of the external unit are shown, corresponding counterparts 28 of opposite polarity are provided at the implantable unit 12.

FIG. 3 shows an example, wherein the polarity of the magnets has a non-circular symmetry in the vertical plane. The line connecting the N and S poles of the permanent magnet 26 extends in a vertical plane in order to prevent rotation of the external unit 10 relative to the implantable unit 12. In particular, such vertical plane usually corresponds to a plane normal to the axis of the transmission coil(s) 40, 54.

According to an alternative embodiment, a central magnet having a polarity of circular symmetry in a vertical plane may be replace by a plurality of such magnets which are distributed according to a non-circular symmetry in the vertical plane. Such a configuration is expected to reduce power losses caused by eddy currents. To this end, the magnets also may be provided with cuts.

FIG. 4 shows an alternative arrangement of the fixation magnets, wherein the external unit 10 comprises two fixation magnets 26A, 26B which are located outside the transmission coil(s) 40, 54 and opposite to each other, with the line connecting the poles of each magnet being oriented essentially horizontal, i.e. parallel to the axis of the coil(s) 40, 54, and with the magnets 26A and 26B having opposite polarity. By placing the magnets outside the coil(s) 44, 54, power losses due to eddy currents can be reduced. Preferably, at least some of the magnets or all of the magnets are located outside the area enclosed by the coils.

For recharging of the rechargeable battery 50, the external unit 10 is removed from the patient's head and is coupled to a charging device 62 comprising a receptacle 64 for receiving the external unit 10 in a predefined orientation, a charging coil 66, a charging circuit 68, a charging controller 70, some kind of power supply 78, and a charging status indicator 76, such as a LED.

In order to achieve a predefined position of the external unit 10 with regard to the charging device 62, the receptacle 64 of the charging device 62 may have a certain inner shape which matches with the outer shape of an engagement portion 72 of the external unit 10. The outer shape of the engagement portion 72 and the inner shape of the receptacle 64 may have a non-circular symmetry. However, in case that the power transmission coil 54 of the external unit 10 and the charging coil 66 of the charging device 62 have a circular symmetry, also the engagement portion 72 and the receptacle 64 may have a circular symmetry. The outer shape of the engagement portion 72 and the inner shape of the receptacle 64 may be designed to keep the external unit 10 in the receptacle 64 by elastic forces.

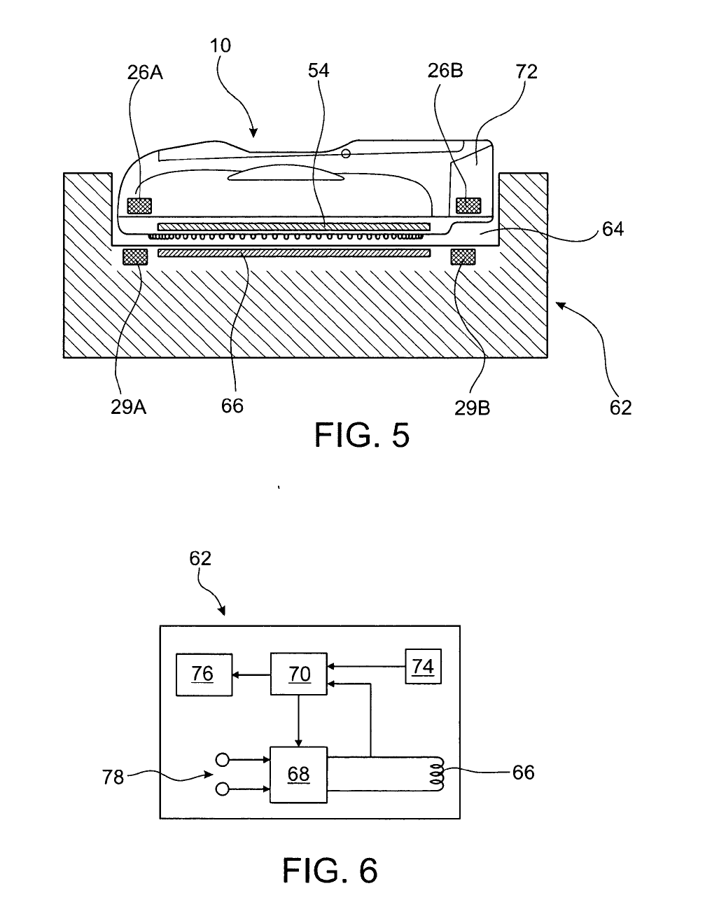

As an alternative or an addition, the charging device 62 may be provided with at least one magnetic element (labeled 29A and 29B in FIG. 5) which cooperates with the magnetic element(s) 26 (or 26A, 26B) of the external unit 10 in a manner that the external unit 10 is coupled to the charging device 62 in a predefined orientation. The magnetic element(s) 26, 26A, 26B of the external unit 10 and the magnetic element(s) 29A, 29B of the charging device 62 may be arranged according to a non-circular symmetry (however, in case of a circular symmetry of the charging coil 66 and the power transmission coil 54, the magnets may be arranged also according to a circular symmetry).

Typically, the (rotational) orientation of the external unit 10 with regard to the charging device 62 is not very important, in particular if the charging coil 66 is larger than the power transmission coil 54. However, the position of the external unit 10 with regard to the charging device 62 is important in that for efficient charging the power transmission coil 54 should rest within the area of the charging coil 66 (where the alternating magnetic field is relatively uniform).

The charging circuit 68 of the charging device 62 is designed to generate an AC signal to the charging coil 66 in order to create an alternating magnetic field for inducing an AC voltage in the power transmission coil 54 of the external unit 10. To this end, the charging coil 66 and the power transmission coil 54 are preferably located coaxially with regard to each other during charging (in particular if the charging coil 66 and the power transmission coil are of similar size), which preferred poisitioning is ensured by the shape of the receptacle 64 and/or the magnets 29A, 29B. When the external unit 10 is charging, the recharging circuitry 53 is turned on by the control unit 55 (or by an automatic switch included in the recharging circuitry 53, such as the switching unit 86 of FIG. 7), whereas the power transmission unit 52 is turned off. The recharging circuitry 53 is for transforming the AC voltage induced in the power transmission coil 54 by the charging device 62 into a DC charging current for recharging the rechargeable battery 50.

The charging controller 70 of the charging device 62 may comprise or is connected to a sensor 74 for detecting the presence of the external unit 10 at the charging device 62, wherein the charging controller 70 is designed to start charging of the power source 50 of the external unit 10 once the presence of the external unit 10 at the charging device 62 has been detected. The sensor 74, for example, may be an optical detector forming optical barrier, or a magnetic detector (Hall sensor) sensing the presence of the fixation magnet(s) 26, 26A, 26B: Alternatively, the presence of the external unit 10 may be detected by measuring the increase in power consumption by the charging coil 66 when the coupled load, i.e. the external unit 10, approaches the charging coil 66.

The charging controller 70 is also able to detect the charging status of the rechargeable battery 50 of the external unit 10 (for example, by monitoring the current through the charging coil 66) and is designed to stop charging of the rechargeable battery 50 of the external unit 10 once full charging of the rechargeable battery 50 has been detected.

As already mentioned above, the charging device 62 also may comprise a LED as charging status indicator which is controlled by the charging controller 70 in a manner so as to enable the charging device 62 to provide for an optical alert signal once full charging of the rechargeable battery 50 of the external unit 10 has been detected. Alternatively or in addition, the charging device 62 may be designed to provide for an acoustic alert signal in this case (provided that the user has sufficient residual hearing).

Once the charging device 62 has indicated, via a respective signal of the LED 76, that the external unit 10 has been fully recharged, the user may remove the external unit 10 from the receptacle 64 of the charging device 62 and may fix it again at the head in order to resume operation of the hearing instrument.

The charging controller 70 typically not only starts and stops the charging process, but it also controls the charging sequence by determining the charging current as a function of the charging status of the battery 50.

Recharging of the external unit 10 may occur during night, when operation of the hearing instrument is not needed. Alternatively, two pieces of the external unit 10 may be provided, with one of them being recharged while the other one is operating.

Typically, the rechargeable power supply 50 will be a rechargeable electrochemical battery. However, it is also conceivable to use a capacitor, such as supercap, as the rechargeable power supply 50. While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1-23. (canceled)

24. A system comprising a partially implantable hearing instrument and a charging device, the hearing instrument comprising an implantable unit and an external unit, wherein the external unit is fixable at a patient's head and comprises an audio signal source, an audio signal processing unit for processing the audio signals provided by the audio signal source, a rechargeable power source, means for transmitting processed audio signals via a transcutaneous audio link to the implantable unit and a power transmission coil for transmitting power via a transcutaneous power link to the implantable unit, wherein the implantable unit comprises means for stimulating a patient's middle ear or inner ear hearing component according to the processed audio signals, wherein the external unit is adapted to be coupled to the inductive charging device for inducing an AC voltage in the power transmission coil, and wherein the external unit comprises recharging circuitry for transforming the AC voltage induced in the power transmission coil by the charging device into a charging current for recharging the rechargeable power source.

25. The system of claim 24, wherein the external unit comprises means for fixing the external unit in a releasable manner at the patient's head.

26. The system of claim 25, wherein the external unit comprises a least one magnetic element for cooperating with a mating implantable magnetic element.

27. The system of claim 25, wherein the external unit is designed to be removed from the patient's head for being coupled to the charging device.

28. The system of claim 27, wherein the external unit is designed to be coupled to the charging device in a predefined position.

29. The system of claim 28, wherein the housing of the external unit comprises an engagement portion to be placed in a receptacle of the charging device, wherein an outer shape of the engagement portion matches with an inner shape of the receptacle.

30. The system of claim 29, wherein the outer shape of the engagement portion and the inner shape of the receptacle have a non-circular symmetry.

31. The system of claim 29, wherein the outer shape of the engagement portion and the inner shape of the receptacle are adapted for keeping the external unit in the receptacle by elastic forces.

32. The system of claim 26, wherein the charging device comprises at least one magnetic element for cooperating with the at least one magnetic element of the external unit in manner coupling the external unit to the charging device in said predefined orientation.

33. The system of claim 32, wherein the at least one magnetic element of the external unit and the at least one magnetic element of the charging device are arranged according to a non-circular symmetry.

34. The system of claim 24, wherein the charging device comprises a charging controller which is adapted for detecting a presence of the external unit at the charging device and to start charging of the power source of the external unit once the presence of the external unit at the charging device has been detected.

35. The system of claim 34, wherein the charging device comprises an optical or magnetic sensor to detect the presence of the external unit at the charging device.

36. The system of claims 34, wherein the charging device comprises means for detecting the presence of the external unit at the charging device by measuring a power consumption of a charging coil of the charging device.

37. The system of claim 34, wherein the charging controller is adapted for detecting a charging status of the power source of the external unit and to stop charging of the power source of the external unit once full charging of the power source of the external unit has been detected.

38. The system of claim 37, wherein the charging controller is adapted to cause the charging device to provide for at least one of an optical alert signal and an acoustic alert signal via a charging status indicator once full charging of the power source of the external unit has been detected.

39. The system of claim 24, wherein the recharging circuitry of the external unit is adapted for transforming the AC voltage induced in the power transmission coil by the charging device into a DC current.

40. The system of claim 39, wherein the rechargeable power source is a rechargeable battery.

41. The system of claim 24, wherein the charging device comprises a coil for generating an alternating magnetic field in order to induce said AC voltage in the power transmission coil of the external unit.

42. The system of claim 24, wherein the power transmission coil forms part of the audio signal transmission means.

43. The system of claim 24, wherein the external unit comprises means for detecting a presence of the charging device and switching the external unit into a charging mode once the presence of the charging device has been detected.

44. The system of claim 43, wherein the external unit comprises means for sensing the voltage induced in the power transmission coil.

45. The system of claim 24, wherein the stimulation means is one of a cochlear implant electrode and an implantable electromechanical actuator.
